(19) United States
(12) Patent Application Publication
(10) Pub. No.: US 2021/0143750 A1
(43) Pub. Date: May 13, 2021

(54) Modular Inverter

(71) Applicant: Siemens Aktiengesellschaft, München (DE)

(72) Inventor: Gopal Mondal, Erlangen (DE)

(73) Assignee: Siemens Aktiengesellschaft, München (DE)

(21) Appl. No.: 16/488,850

(22) PCT Filed: Jan. 23, 2018
(86) PCT No.: PCT/EP2018/051512

§ 371 Date: Aug. 26, 2019

(30) Foreign Application Priority Data
Feb. 28, 2017 (DE) 10 2017 203 233.2

(51) Int. Cl. H02M 7/487; H02M 7/537; H02M 3/158; H02M 1/42

(52) U.S. Cl. CPC H02M 7/487; H02M 7/537; H02M 2001/007; H02M 1/42; H02M 3/158

(57) ABSTRACT

A converter module for a modularly configured inverter may include: a first and a second module terminal each having a positive contact, a negative contact, and a reference potential contact; a first semiconductor switch connected to the positive contacts; a second semiconductor switch connected to the negative contacts; an inductor connected to the reference potential contacts; a first series circuit comprising a third switch and a capacitor in parallel to the first switch; and a second series circuit comprising a fourth switch and a second capacitor in parallel to the second switch.

### CROSS-REFERENCE TO RELATED APPLICATIONS

This application is a U.S. National Stage Application of International Application No. PCT/EP2018/051512 filed Jan. 23, 2018, which designates the United States of America, and claims priority to DE Application No. 10 2017 203 233.2 filed Feb. 28, 2017, the contents of which are hereby incorporated by reference in their entirety.

### TECHNICAL FIELD

The present disclosure relates to converter module. Various embodiments may include inverters.

### BACKGROUND

One particular category of modular inverters is, for example, multi-level energy converters, which are frequently used in the field of high-voltage direct current transmission (HVDC), wherein the DC voltages are provided in the range of several 100 kV, and power is provided in a range of 1 GW. In the case of such multi-level energy converters, the conversion essentially takes place without a major change in the voltage level, i.e., the level of a maximum amplitude of the AC voltage essentially corresponds to a half level of a DC voltage which is present at a DC voltage intermediate circuit.

Generic multi-level energy converters generally comprise a series circuit made up of a plurality of converter modules which, for their part, comprise a converter module capacitor and a series circuit which is connected in parallel with it and which is made up of two semiconductor switches connected in series. Due to the circuit structure, the control of the converter modules is comparatively reliable compared to alternative circuit designs; therefore, the multi-level energy converter is particularly suitable for applications in the HVDC range. In addition, the multi-level energy converter having a generic intermediate circuit design does not require an intermediate-circuit capacitor, which, moreover, would prove to be highly complex and costly in an application in the HVDC range. Corresponding support of the DC voltage intermediate circuit is achieved by means of the converter module capacitors. In the English-language literature, generic multi-level energy converters are also described as modular multi-level converters, MMCs, or M2Cs.

As a result of progressive price reductions in the field of electronic components, even complex topologies or circuit structures now fall increasingly within the scope of the power electronics mass market. Since the complex circuit approaches have generally been developed for the medium- or high-voltage range, many requirements have been fulfilled in a relatively elaborate or complex manner because of the constraints which are prevalent at these voltages. When applying such topologies or circuit structures to the low-voltage range, in particular low voltages in the range of 500 V or less, a number of requirements can be achieved in a simpler and more efficient manner. Multi-level energy converters, in particular generic inverters which are formed by means of such multi-level energy converters, have performed well in the field of energy technology applications of the aforementioned type. In principle, such multi-level energy converters could of course also be implemented at lower voltages. As a result, it is possible take advantage of the very high efficiency which multi-level energy converters can provide, the low switching losses, and the high reliability in comparison to other energy converters.

Even if the use of multi-level energy converters as inverters has also proven to be feasible in principle at low voltages, in particular lower low voltages, a number of problems arise particularly at low voltages, in particular on the DC-voltage side. The need for reliable and highly effective inverters has increased in particular due to the high use of regenerative energy, for example, by photovoltaic facilities or the like. Although high efficiency and high reliability can be achieved for an inverter via the multi-level energy converter, the conventional basic circuit structure of the series-connected converter modules has proven to be disadvantageous. In particular, such a multi-level energy converter is generally not suitable for enabling voltage conversion from a low intermediate circuit-side DC voltage to a high AC voltage without using an additional transformer. In addition, for inverters in this field, it would be advantageous if an adaptation to a wide variety of voltage supplies, in particular on the DC-voltage side, could be achieved in a simple manner without having to develop, test, and release a new structure every time.

### SUMMARY

The object of the present invention is therefore to provide an inverter which is capable of exploiting the advantages of a multi-level energy converter, but which is at the same time also reliably useful in particular at very low intermediate-circuit DC voltages. For example, some embodiments include a converter module (10) for a modularly configured inverter (30), characterized by: a first and a second module terminal (12, 14), wherein each of the module terminals (12, 14) has a positive contact (16), a negative contact (18), and a reference potential contact (20), a first semiconductor switch (S1) which is connected to the positive contacts (16) of the two module terminals (12, 14) for electrically coupling the positive contacts (16), a second semiconductor switch (S7) which is connected to the negative contacts (18) of the two module terminals (12, 14) for electrically coupling the negative contacts (18), an inductor (L_{chrg}) which is connected to the reference potential contacts (20) of the two module terminals (12, 14) for electrically coupling the reference potential contacts (20), a first series circuit (22) which is made up of a third semiconductor switch (S2) and a first capacitor (C1) and which is connected in parallel with the first semiconductor switch (S1), wherein the first capacitor (C1) is connected to the positive contact (16) of the first module terminal (12), the third semiconductor switch (S2) is connected to the positive contact (16) of the second module terminal (14), and a connection (26) of the third semiconductor switch (S2) to the first capacitor (C1) is connected to the reference potential contact (20) of the first module terminal (12) via a fifth semiconductor switch (S3), and a second series circuit (24) made up of a fourth semiconductor switch (S6) and a second capacitor (C2), which is connected in parallel with the second semiconductor switch (S7), wherein the second capacitor (C2) is connected to the negative contact (18) of the first module terminal (12), the fourth semiconductor switch (S6) is connected to the negative contact (18) of the second module terminal (14), and a connection (28) of the fourth semiconductor switch (S6) to the second capacitor (C2) is connected to the reference potential contact (20) of the first module terminal (12) via a sixth semiconductor switch (S5).

In some embodiments, there is a control unit which is integrated into the converter module (10) for controlling the semiconductor switches (S1, S2, S3, S5, S6, S7).

In some embodiments, the first and the second module terminal (12, 14) respectively have a control terminal.

In some embodiments, the first and the second module terminal (12, 14) respectively include a coded plug connector unit which comprises at least the respective positive contact (16), the respective negative contact (18), the respective reference potential contact (20), and optionally the control terminal. As another example, some embodiments include an inverter (30) comprising: at least one AC-voltage terminal (32) which has a phase terminal (R) and a neutral conductor terminal, and a DC-voltage terminal (38) which has a positive contact (16), a negative contact (18), and a reference potential contact (20), wherein the reference potential contact (20) and the neutral conductor terminal are electrically coupled to one another, characterized by a module receptacle (34) including an inverter module terminal (36) which has a positive contact (16), a negative contact (18), and a reference potential contact (20), wherein each of the contacts (16, 18, 20) is electrically coupled to the phase contact (R) by means of a respective seventh, eighth, and ninth semiconductor switch (S8, S9, S10), wherein the module receptacle (34) is configured to electrically connect at least one converter module (10) as claimed in one of the preceding claims, in that the inverter module terminal (36) electrically couples the first module terminal (12) of the at least one converter module (10), and the DC-voltage terminal (38) electrically couples the second module terminal (14) of the at least one converter module (10).

In some embodiments, the module receptacle (34) is configured as a converter module (10) to electrically connect a cascade (40) made up of at least two converter modules (10) as claimed in one of claims 1 to 4, wherein for configuring the cascade (40), respective first module terminals (12) of a respective one of the converter modules (10) are electrically connected to respective second module terminals (14) of respective additional converter modules (10), wherein the module receptacle (34) is configured to electrically couple the inverter module terminal (36) to a free first module terminal (12) of the cascade (40), and to electrically couple the DC-voltage terminal (38) to a free second module terminal (14) of the cascade (40).

In some embodiments, there is an inverter controller which is connected to a module control terminal of the inverter module terminal, wherein the module control terminal is configured to be coupled to a control terminal of the converter module (10).

In some embodiments, the ninth semiconductor switch (S9) is configured for the bidirectional electrical disconnection of the reference potential contact (20) from the phase contact (R) in a deactivated switching state.

### BRIEF DESCRIPTION OF THE DRAWINGS

Advantages and features may be extracted from the following description of example embodiments, based on the figures. In the figures, identical reference numerals refer to identical components and functions. The following is depicted:

FIG. 1 depicts a schematic circuit diagram of a converter module incorporating teachings of the present disclosure;

FIG. 2 depicts a schematic circuit diagram of an inverter incorporating teachings of the present disclosure comprising a converter module according to FIG. 1;

FIG. 3 depicts a schematic circuit diagram of an inverter as in FIG. 2, wherein here, a number of cascaded converter modules is provided;

FIG. 4 depicts a schematic circuit diagram of a three-phase inverter which comprises single-phase inverters according to FIG. 3;

FIG. 5 depicts the inverter according to FIG. 2 in a first switching state for providing a first voltage level to a phase terminal;

FIG. 6 shows a depiction as in FIG. 5, but in a second switching state for providing a second voltage level at the phase terminal;

FIG. 7 shows a depiction as in FIG. 5, in a third switching state for providing a third voltage level at the phase terminal;

FIG. 8 shows a depiction as in FIG. 5, in a fourth switching state for providing a fourth voltage level at the phase terminal;

FIG. 9 shows a depiction as in FIG. 5, in a fifth switching state for providing a fifth voltage level at the phase terminal;

FIG. 10 shows a schematic diagram depiction of a voltage at one of the phase terminals of the inverter according to FIG. 4;

FIG. 11 shows a schematic diagram depiction of a phase voltage between two phases of the inverter according to FIG. 4;

FIG. 12 shows a schematic diagram depiction of a voltage range of a first and a second capacitor of the converter module according to FIG. 1;

FIG. 13 shows a schematic diagram depiction of a module current flowing through the converter module according to FIG. 1; and

FIG. 14 shows a schematic representation of AC currents at the respective phase terminals of the inverter according to FIG. 4.

### DETAILED DESCRIPTION

In some embodiments, a converter module comprises a first and a second module terminal, wherein each of the module terminals has a positive contact, a negative contact, and a reference potential contact, wherein the converter module further comprises a first semiconductor switch which is connected to the positive contacts of the two module terminals for electrically coupling the positive contacts, and a second semiconductor switch which is connected to the negative contacts of the two module terminals for electrically coupling the negative contacts, and further comprises an inductor which is connected to the reference potential contacts of the two module terminals for electrically coupling the reference potential contacts. Furthermore, a first series circuit is provided which is made up of a third semiconductor switch and a first capacitor and which is connected in parallel with the first semiconductor switch, wherein the first capacitor is connected to the positive contact of the first module terminal, the third semiconductor switch is connected to the positive contact of the second module terminal, and a connection of the third semiconductor switch to the first capacitor is connected to the reference potential contact of the first module terminal via a fifth semiconductor switch.

Furthermore, a second series circuit made up of a fourth semiconductor switch and a second capacitor is provided, which is connected in parallel with the second semiconductor switch, wherein the second capacitor is connected to the positive contact of the first module terminal, the fourth semiconductor switch is connected to the positive contact of the second module terminal, and a connection of the fourth semiconductor switch to the second capacitor is connected to the reference potential contact of the first module terminal via a sixth semiconductor switch.

In some embodiments, an inverter comprises a module receptacle including an inverter module terminal which has a positive contact, a negative contact, and a reference potential contact, wherein each of the contacts is electrically coupled to the phase contact by means of a respective seventh, eighth, and ninth semiconductor switch, wherein the module receptacle is configured to electrically connect at least one converter module according to the present invention, in that the inverter module terminal electrically coupled the first module terminal of the at least one converter module, and the DC-voltage terminal electrically coupled the second module terminal of the at least one converter module.

By means of the teachings of the present disclosure, it is thus possible to be able to customize an inverter to a wide variety of requirements in a simple manner, in that a corresponding converter module or a corresponding number of converter modules are arranged in the inverter, i.e., in the module receptacle of said inverter. Thus, by means of the converter module incorporating the teachings herein, it can be achieved in a simple manner that the inverter is capable of providing a voltage transformation, in which an amplitude of an AC voltage provided by the inverter can be greater than a DC voltage at the intermediate circuit of the inverter. Embodiments of the present disclosure are suitable in particular for the low-voltage range, e.g. in the field of regenerative energy, in which, for example, a DC voltage is provided by means of photovoltaics, which is to be converted into an AC voltage by means of the inverter, in order, for example, to be able to feed it into a public power grid or the like.

In the context of the present disclosure, the term “low voltage” may be understood to mean in particular a definition according to Directive 2006/95/EC of the European Parliament and of the Council of 12 Dec. 2006 on the harmonization of the laws of member states relating to electrical equipment designed for use within certain voltage limits. However, the present invention is not limited to this voltage range but may also be used in the medium-voltage range, which may comprise a voltage range from greater than 1 kV up to and including 52 kV. In principle, the teachings of the present disclosure may of course also be used in the high-voltage range, wherein here, however, corresponding complexity is to be provided in the area of the converter modules.

The structure of the converter module incorporating the teachings herein allows it to be cascaded in virtually any manner, so that it is possible in a simple manner to provide an inverter which allows the DC voltage of the intermediate circuit to be converted into an AC voltage having a higher amplitude. Even though the conversion principle is described below based only on a single AC voltage phase, it should be obvious to those skilled in the art that for additional AC voltage phases, in particular for supplying a three-phase AC grid, corresponding extensions to the inverter are provided which can be added for each phase in a manner similar to that of single-phase operation.

In the context of this disclosure, a semiconductor switch may comprise a controllable electronic switching element, for example, a controllable electronic semiconductor switch such as a transistor, a thyristor, combination circuits thereof, preferably having flyback diodes connected in parallel, a gate-turn-off thyristor (GTO), an insulated-gate bipolar transistor (IGBT), combinations thereof, or the like. In principle, the semiconductor switch may also be formed by a metal-oxide semiconductor field-effect transistor (MOSFET). In some embodiments, the semiconductor switch is controllable by a control unit of the converter module.

In the context of this disclosure, semiconductor switches acting as switching elements are operated in switching mode. The switching mode of a semiconductor switch means that in an activated state, a very low electrical resistance is provided between the terminals of the semiconductor switch forming the switching path, so that a high current flow is possible having a very low residual voltage. In the deactivated state, the switching path of the semiconductor switch has high resistance, i.e., said switching path provides a high electrical resistance, so that even when a high voltage is applied to the switching path, essentially no current flow, or only a very small, in particularly negligible, current flow, is present. This differs from linear operation, which, however, is not used in generic inverters.

By means of the module receptacle, the inverter provides a connection facility for the converter module. The connection facility comprises the inverter module terminal and a coupling facility to the DC-voltage terminal of the inverter. On the one hand, the converter module which is arranged in the module receptacle may thereby be connected to the intermediate circuit of the inverter via the DC-voltage terminal, and on the other hand, may be connected to the phase terminal via an electronic circuit on the module receptacle side. The circuit of the inverter on the module receptacle side provides the inverter module terminal.

As a result, in connection with the converter module, a circuit structure is created which allows electrical energy which is provided on the DC-voltage side to be converted into electrical energy which is provided at the AC-voltage terminal, and vice-versa. The inverter incorporating teachings of the present disclosure is thus suitable not only for unidirectional energy conversion but can furthermore be used for converting energy in the reverse direction, i.e., for bidirectional energy conversion. The semiconductor switches are to be activated accordingly. For this purpose, a superordinate controller may be provided on the inverter side, for example, an inverter controller, which is capable of controlling not only the semiconductor switches of the module receptacle, i.e., the seventh, eighth, and ninth semiconductor switches, but preferably also the semiconductor switches of the converter module or converter modules. For this purpose, corresponding coupling to the converter modules may be provided for communication purposes.

To connect the converter module to the module receptacle of the inverter, a plug connector may be provided which allows the converter module to be connected to the module receptacle of the inverter in a simple manner. In some embodiments, only a single plug connector is provided, so that the converter module can be arranged in the module receptacle in a simple manner. In some embodiments, the plug connector includes coding so that reverse polarity can be avoided. The first and the second module terminal of the converter module may thus be simultaneously connected in the module receptacle. In addition, this design is of course also suitable for being able to exchange converter modules in a simple manner, for example, if a converter module is defective or requires maintenance, or if the inverter is to be adapted to other electrical requirements.

By means of the inverter incorporating teachings of the present disclosure, in connection with the converter module, it is possible to convert a low DC voltage into a high AC voltage in a simple manner. Likewise, a high AC voltage can be converted into a low DC voltage, as required. In this case, the AC voltage may be a single-phase AC voltage as well as a multiphase AC voltage, in particular a three-phase AC voltage. Due to the circuit structure of the converter module and the module receptacle, a waveform for the AC voltage may be provided on the AC-voltage side like that which is also achievable via a multi-level energy converter of the generic type.

Each of the converter modules has six semiconductor switches, two electrical capacitors, and an electrical inductor, in order to be able to achieve the desired converter function. By suitably controlling the semiconductor switches, it is possible to balance voltages of the two capacitors in a predefinable manner, so that reliable conversion function can be achieved. In this case, the inductor may be used to limit a charging current for the capacitors. The inductor needs to have just a small value to be able in particular to limit switch-on current spikes. If applicable, even a piece of wire may be sufficient. On the module receptacle side, three semiconductor switches are provided which only have to be arranged once per phase for the inverter.

By means of the converter module incorporating teachings of the present disclosure, it is possible to generate five different voltage levels using one converter module. If a multiphase inverter is provided in which a single converter module is provided for each phase, a resolution having nine different voltage levels may be achieved in the case of a voltage between two phases. The converter module generates the different voltage levels by correspondingly switching its semiconductor switches in connection with the semiconductor switches of the module receptacle. This will be described further below.

Overall, it is possible in a simple manner to provide an inverter which allows a low DC voltage to be converted into a high AC voltage and vice-versa. In addition, the inverter makes customization possible in a simple manner and makes it possible to fabricate large piece quantities economically, in particular because the module receptacle as well as the converter modules can be standardized and can be combined as separately tested assemblies.

In some embodiments, the converter module comprises a control unit which is integrated into the converter module for controlling the semiconductor switches. It is thus possible to achieve reliable control of the semiconductor switches of the converter module in a simple manner. This may be advantageous if the converter module is to undergo a test during production or during maintenance. In this way, control commands can be conveyed to the converter module, which can then be converted into suitable switching functions of the semiconductor switches. It is thus not necessary to provide each individual semiconductor switch of the converter module with a separate customized control signal. As a result, the converter module can be designed to be particularly immune to electrical noise, in particular because control lines for individual semiconductor switches can be very short.

In some embodiments, the first and the second module terminal respectively include a control terminal. As a result, a facility for controlling the converter module is provided by merely connecting a control unit to the control terminal. It is thus not necessary to provide separate terminals for the individual semiconductor switches. As a result, the assembly and the production complexity may be reduced. In some embodiments, the control terminal is integrated into a plug connector via which the first module terminal and optionally the second module terminal are also simultaneously provided. As a result, assembly complexity may be reduced, and the flexibility with respect to the design of the inverter may be increased. The control terminal may also be implemented in the manner of a plug connector, for example, by providing suitable plug connector elements at the first and optionally also at the second module terminal.

In some embodiments, the first and the second module terminal respectively include a coded plug connector unit which comprises at least the respective positive contact, the respective negative contact, the respective reference potential contact, and optionally also the control terminal. Separate plug connector units may be provided for the first and the second module terminal. In some embodiments, the first and the second module terminal include a shared plug connector unit, so that only a single plug connection is to be carried out in order to be able to establish the connection with the module receptacle. On the other hand, if it is provided that the converter modules are cascaded, as described below, it may be advantageous to provide separate plug connector units for the first and the second module terminal. The plug connector units may be standardized, so that the converter modules can be cascaded in virtually any manner.

In some embodiments, the module receptacle is configured as a converter module to connect a cascade made up of at least two converter modules as taught herein, wherein for configuring the cascade, respective first module terminals of a respective one of the converter modules are electrically connected to respective second ones of the module terminals of respective additional converter modules, wherein the module receptacle is configured to electrically couple the inverter module terminal to a free first module terminal of the cascade, and to electrically couple the DC-voltage terminal to a free second module terminal of the cascade. As a result, it is possible in a simple manner to provide almost any levels of transformation with respect to a voltage transformation, as well as with respect to a resolution to voltage levels. It may also be provided that a corresponding number of converter modules are provided as needed, in order to be able to implement a correspondingly high voltage transformation. In addition, it may also be provided that a number of converter modules is increased if an improved resolution with respect to the voltage level is desired. The teachings of the present disclosure allow this to be implemented in a simple manner by providing only a corresponding additional number of converter modules in the inverter.

In some embodiments, the inverter comprises an inverter controller which is connected to a module control terminal of the inverter module terminal, wherein the module control terminal is configured to be coupled to a control terminal of the converter module. As a result, it is possible in a simple manner to provide an inverter-side option for controlling the converter module. In some embodiments, corresponding plug connectors are provided for this purpose, which can be integrated into the corresponding terminals. By arranging the converter module in the module receptacle, the converter module can thus also be connected simultaneously using control technology.

In some embodiments, the inverter controller detects how many converter modules are arranged in the module receptacle, and what the type is of a respective converter module which is arranged in the module receptacle, in order to be able to adjust the control of the converter modules correspondingly, preferably in an automated manner. Thus, converter modules may be configured for different levels of performance, requiring corresponding consideration with respect to the control option. By means of the inverter control, it is possible in a simple manner to control the converter modules correspondingly and thus to provide reliable function of the inverter. In some embodiments, in the case of a cascade of converter modules, the control terminals of the converter modules are also cascaded, so that control of all converter modules may be achieved via just a single control terminal.

In some embodiments, the ninth semiconductor switch is configured for the bidirectional electrical disconnection of the reference potential contact from the phase contact in a deactivated switching state. As a result, a complete disconnection of the reference potential contact from the phase contact may be achieved. The ninth semiconductor switch may be implemented via a series connection of transistors, thyristors, and/or the like which are connected antiserially, as already discussed above.

In the field of renewable energy, it is often necessary to convert a low DC voltage into a high, useful AC voltage. In the prior art, for this purpose, it is generally provided that the low DC voltage is initially converted into a low AC voltage and then transformed using a transformer in order to be able to convert the supplied AC voltage into a high AC voltage. The use of a transformer reduces the efficiency of the circuit and simultaneously the flexibility with respect to adjusting voltage levels, because the transformer generally does not allow modularity. For different ratios of input voltage and output voltage, it is necessary in each case to design new transformers.

In some embodiments, modularity is provided which allows a ratio of an input voltage to an output voltage to be adjusted in a simple manner, as a function of a respective application. In this case, the teachings of the present disclosure enable an adjustment based on the control of the inverter, in particular the converter module, as well as enabling an additional adjustment by means of virtually any level of cascading of converter modules. This is obtained based on the following exemplary embodiments, for which simulations have also been carried out, as will be described below. Overall, a multi-level conversion is made possible which has few harmonics at a phase terminal. The number of voltage levels increases with the number of converter modules which are arranged in a cascaded manner in a respective inverter.

The modular design of an inverter incorporating the teachings herein makes it possible to adjust possible voltage levels in virtually any manner, for example, by adding or removing converter modules, and by adjusting the respective control. As a result of the fact that the inverter does not require high switching frequencies in order to maintain voltages of capacitors of the converter modules, switching losses with respect to known inverter designs are correspondingly low. In addition, the circuit design according may be controlled in a simple manner in order to achieve internal voltage balancing.

In this regard, FIG. 1 depicts a schematic circuit diagram of an embodiment of a converter module 10 according to the present invention. The converter module 10 is provided for a modularly configured inverter 30 (FIG. 2). The converter module 10 comprises a first and a second module terminal 12, 14, wherein each of the module terminals 12, 14 respectively has a positive contact 16, a negative contact 18, and a reference potential contact 20. A first semiconductor switch S1 is connected to the positive contacts 16 of the two module terminals 12, 14 for electrically coupling the positive contacts 16. In a similar way, a second semiconductor switch S7 is connected to the negative contacts 18 of the two module terminals 12, 14 for electrically coupling the negative contacts 18. Furthermore, an inductor L_{chrg} is connected to the reference potential contacts 20 of the two module terminals 12, 14 for electrically coupling the reference potential contacts 20.

The converter module 10 furthermore comprises a first series circuit 22 which is made up of a third semiconductor switch S2 and a first capacitor C1 and which is connected in parallel with the first semiconductor switch S1. The first capacitor C1 is connected to the positive contact 16 of the first module terminal 12, and the third semiconductor switch S2 is connected to the positive contact 16 of the second module terminal 14. Furthermore, a connection 26 of the third semiconductor switch S2 to the first capacitor C1 is connected to the reference potential contact 20 of the first module terminal 12 via a fifth semiconductor switch S3.

From FIG. 1, it is further apparent that the converter module 10 comprises a second series circuit 24 made up of a fourth semiconductor switch S6 and a second capacitor C2, which, similarly to the first series circuit 22, is connected in parallel with the second semiconductor switch S7. The second capacitor C2 is connected to the negative contact 18 of the first module terminal 12, the fourth semiconductor switch S6 is connected to the negative contact 18 of the second module terminal 14, and a connection 28 of the fourth semiconductor switch S6 to the second capacitor C2 is connected to the reference potential contact 20 of the first module terminal 12 via a sixth semiconductor switch S5. The second series circuit 24 is therefore also configured similarly to the first series circuit 22.

As will be depicted below, the circuit structure of the converter module 10 selected here has particular characteristics which allow not only low DC voltages to be converted to high AC voltages, but which also allow enabling virtually any level of modularity and cascading of converter modules 10.

FIG. 2 depicts a schematic circuit diagram of an inverter 30 comprising an AC-voltage terminal 32 which has a phase terminal R and a neutral conductor terminal which is not depicted further. The inverter 30 further comprises a DC-voltage terminal 38 which has a positive contact 16, a negative contact 18, and a reference potential contact 20. The reference potential contact 20 and the neutral conductor terminal are electrically coupled to one another; however, this is not depicted in FIG. 2. Thus, a DC voltage is supplied to the inverter 30 as an intermediate-circuit DC voltage, which is formed symmetrically with respect to the reference potential contact 20, so that at the positive contact 16, the magnitude of the voltage with respect to the reference potential contact 20 is the same as with respect to the negative contact 18 in relation to the reference potential contact 20.

The inverter 30 further comprises a module receptacle 34 in which a single converter module 10 according to FIG. 1 is presently arranged. The module receptacle 34 further comprises an inverter module terminal 36 having a positive contact 16, a negative contact 18, and a reference potential contact 20. Each of the contacts 16, 18, 20 of the inverter module terminal 36 is electrically coupled to the phase contact R by means of a respective seventh, eighth, and ninth semiconductor switch S8, S9, S10.

The module receptacle 34 is configured to electrically connect the converter module 10 in that the inverter module terminal 36 electrically couples the first module terminal 12 of the converter module 10, and the DC-voltage terminal 38 electrically couples the second module terminal 14 of the converter module 10. Due to the design of the inverter 30, it is possible to provide an AC voltage at the phase terminal R which is capable of assuming five different levels. This will be described in greater detail below based on FIGS. 5 to 10. In some embodiments, IGBTs including an integrated flyback diode are used as semiconductor switches S1 to S10.

FIG. 3 depicts a schematic circuit diagram of a further embodiment of the inverter 30, which in principle is based on the embodiment of the inverter 30 according to FIG. 2; thus, additional reference will be made to the embodiments in this regard. Unlike the embodiment according to FIG. 2, in the case of the embodiment according to FIG. 3, the module receptacle 34 of the inverter 30 is configured to electrically connect a cascade 40 made up of a plurality of converter modules 10 according to FIG. 1.

In order to configure the cascade 40, respective first module terminals 12 of the respective converter modules 10 are electrically connected to respective second module terminals 14 of respective converter modules 10, so that the cascade 40 can be configured. The module receptacle 34 is configured to electrically couple the inverter module terminal 36 to a free first module terminal 12 of the cascade 40, and to electrically couple the DC-voltage terminal 38 to a free second module terminal 14 of the cascade 40, as is apparent from FIG. 3. As a result, the inverter 30 can be extended or modified in virtually any manner with respect to its inverter function by providing converter modules 10 as needed.

As a result, it is possible to adjust the inverter 30 to a wide variety of operating requirements in a simple manner. In some embodiments, the converter modules 10 are standardized, so that the inverter 30 can be adjusted as needed to specific requirements with a high degree of flexibility, by correspondingly arranging converter modules 10 in the module receptacle 34.

FIG. 4 depicts a refinement which is based on the inverter according to FIG. 3. FIG. 4 depicts an embodiment of an inverter 42 which is presently a three-phase inverter. For this purpose, the inverter 42 comprises an inverter 30 according to FIG. 3, for each of the three phases. On the DC-voltage side, the inverters 30 are connected in parallel, so that their DC-voltage terminals 38 are respectively connected in parallel and form a common intermediate circuit. On the AC-voltage side, each of the inverters 30 provides one phase of the inverter 42. Preferably, the phases R, S, T, which are provided to the respective phase terminals R, S, T, are phase-shifted by approximately 120°.

The function of a converter module, which corresponds to the converter module 10 according to FIG. 1, will now be explained in greater detail below, based on FIGS. 5 to 10. The relevant switching states of the converter module 1 are depicted in the following table.

| V_{Rn} (Phase | | | | | | | | | | |
|---|---|---|---|---|---|---|---|---|---|---|
| voltage | | | | | | | | | | |
| relative to a | Capacitor | | | | | | | | | |
| center point | charge | | | | | | | | | |
| of the DC | balancing | | | | | | | | | |
| voltage or the | state | S1 | S2 | S3 | S5 | S6 | S7 | S8 | S9 | S10 |
| Vdc + Vc | No charging or | 0 | 1 | 0 | 0 | X | 0 | 1 | 0 | 0 |
| | discharging | | | | | | | | | |
| Vdc (charge | Charging C1 | 1 | 0 | 1 | 0 | X | 0 | 1 | 0 | 0 |
| balancing for | No charging or | 1 | 0 | 0 | 0 | X | 0 | 1 | 0 | 0 |
| C1) | discharging | | | | | | | | | |
| | Discharging | 0 | 0 | 1 | 0 | X | 0 | 1 | 0 | 0 |
| | C1 | | | | | | | | | |
| 0 | No charging or | 0 | X | 0 | 0 | X | 0 | 0 | 1 | 0 |
| | discharging | | | | | | | | | |
| | Charging C1 | 1 | 0 | 1 | 0 | X | 0 | 0 | 1 | 0 |
| | Charging C2 | 0 | X | 0 | 1 | 0 | 1 | 0 | 1 | 0 |
| −Vdc | Charging C2 | 0 | X | 0 | 1 | 0 | 1 | 0 | 0 | 1 |
| (Charge | No charging or | 0 | X | 0 | 0 | 0 | 1 | 0 | 0 | 1 |
| balancing for | discharging | | | | | | | | | |
| C2) | Discharging | 0 | X | 0 | 1 | 0 | 0 | 0 | 0 | 1 |
| | C2 | | | | | | | | | |
| −Vdc − Vc | No charging or | 0 | X | 0 | 0 | 1 | 0 | 0 | 0 | 1 |
| | discharging | | | | | | | | | |

FIG. 5 depicts a first switching state, in which the electrical connection in the converter module 10 is depicted by means of a dashed line. There is presently no redundant switching state for this switching state of the converter module 10. During this switching state, the semiconductor switch S2 is activated, so that the cathode of the diode of the semiconductor switch S1 is raised to the highest positive potential, so that a short circuit of C1 is prevented. In this switching state, the voltage level at the phase terminal R is approximately +2 VDC. In this switching state, the other semiconductor switches are deactivated.

FIG. 6 depicts a further switching state of the inverter 30, for which redundant switching states are available for this voltage level (see table). The redundant switching states can be used to charge or discharge the capacitor C1. In the switching state depicted here, only the semiconductor switch S8 is activated. In case of the semiconductor switch S1, the integrated flyback diode is used for the activated state. In this switching state, the voltage level at the phase terminal R is approximately +VDC. In this switching state, the other semiconductor switches are deactivated.

FIG. 7 depicts a third switching state, for which several redundant switching states are also available (see table), in order either to charge or discharge the capacitors C1 and C2. Presently, only the semiconductor switch S9 is activated. The semiconductor switch S9 is presently formed from an antiserial series connection of two IGBTs which are switched jointly for this purpose. In this switching state, the phase terminal R is electrically conductively connected to the reference potential contact 20 via the semiconductor switch S9. The voltage at the phase terminal R is therefore approximately 0 V. In this switching state, the other semiconductor switches are deactivated.

FIG. 8 depicts a further switching state of the inverter 30, in which an electrical voltage of −VDC is provided at the phase terminal R. In this switching state, the semiconductor switch S10 is activated and furthermore uses the flyback diode of the semiconductor switch S7. In this switching state, the other semiconductor switches are deactivated. Here as well, redundant switching states are possible which can be used to charge or discharge the capacitor C2.

FIG. 9 depicts a fifth switching state of the inverter 30, for which a redundant switching state is not possible. In this switching state, a voltage of −2 VDC is provided at the phase terminal R. In this switching state, the semiconductor switches S6 and S10 are activated. The semiconductor switch S7 is deactivated and its flyback diode is biased in the reverse direction due to the application of voltage by the second capacitor C2. In this switching state, the other semiconductor switches are deactivated. The corresponding switching states are also depicted in the table above and may be retrieved from it and may be used to indicate the circumstances under which the first and the second capacitor C1, C2 can be charged or discharged. The switching states may be chosen accordingly.

FIG. 10 depicts a schematic diagram 44 of a voltage profile at the phase terminal R of the inverter 42 according to FIG. 4 with respect to the neutral conductor. An abscissa 50 is the time axis, which depicts time in seconds. An ordinate 48 is a voltage axis, which indicates the voltage at the phase terminal R with respect to the neutral conductor in volts. The voltage profile at the phase terminal R is depicted via a graph 46.

From FIG. 10, it is apparent that the voltage alternatingly assumes five levels in succession, as previously described based on FIGS. 5 to 9. As a result, an AC voltage at the phase terminal R is provided which has only slight distortion with respect to a sinusoidal AC voltage. Filtering can be carried out with minimal filtering measures, should it be required. If the accuracy is to be increased, a cascade 40 may also be arranged in the inverter 30 instead of a single converter module 10 in the inverter 30. The resolution then increases according to the number of converter modules 10.

FIG. 11 depicts a schematic diagram 52 in which the abscissa is also the time axis 50. An ordinate 56 is a voltage axis which depicts a phase voltage between two phases, namely, between the phase terminals R and the phase terminal S of the inverter 42 according to FIG. 4, wherein in this embodiment, the inverter 42 comprises only a single converter module 10 for each of the phases. The voltage is specified in V. The voltage profile is depicted by a graph 54. From FIG. 11, it is apparent that nine stages are available here. The AC voltage between two phases is thereby considerably more finely resolved.

FIG. 12 depicts a schematic voltage-time diagram 58 of a capacitor voltage of one of the two capacitors C1, C2 of the converter module 10 during normal operation. The depiction is essentially approximately identical for the two capacitors. A time axis 60 is provided which indicates time in s. Furthermore, a voltage axis 62 is provided as the ordinate, in which the voltage is depicted in V. A graph 64 specifies a voltage band which depicts a voltage range which corresponds to a capacitor voltage of the first capacitor C1 or the second capacitor C2. From FIG. 12, it is apparent that the capacitor voltage at the first capacitor C1 or at the second capacitor C2 is in a range of approximately 330 V to approximately just under 350 V.

FIG. 13 depicts an additional schematic diagram 66 of a current which flows through the first capacitor C1 or the second capacitor C2 and the corresponding semiconductor switches. The diagram 66 again has the time axis 60 as an abscissa. An ordinate 68 is associated with a module current of the converter module 10, which is specified in A. A graph 70 depicts a range for a current flow through the first capacitor C1 or the second capacitor C2 and the corresponding semiconductor switches. The magnitude of the current can be between −100 A and +100 A.

FIG. 14 shows an additional schematic diagram 72 of a current flow at the phase terminals R, S, T of the inverter 42 according to FIG. 4. The diagram 72 has an abscissa 74 which is a time axis and which depicts time in s. An ordinate 76 is associated with a phase current of a respective phase R, S, T, and represents the current in A. From the diagram 72, three graphs are apparent, in particular, a first graph 78 which is associated with a current of the phase terminal R, a graph 80 which is associated with a current of the phase terminal S, and a graph 82 which is associated with a current of the phase terminal T. It is apparent that the phase currents which are depicted by the graphs 78, 80, 82 are respectively shifted by approximately 120°.

The exemplary embodiments serve only to describe the teachings of the present disclosure and are not restrictive for the same. Of course, functions, in particular also embodiments with respect to the inverter or the converter module, may be designed in any manner without departing from the scope of the present disclosure. Thus, for example, the semiconductor switches may be configured in a dual form as an NPN transistor as well as a PNP transistor. In addition, the semiconductor switches do not have to be configured only as IGBTs but may similarly also be configured as MOSFETs. In addition, additional switching elements and combination circuits thereof may also be provided, for example, using thyristors or the like. If necessary, a circuit structure is to be adapted by those skilled in the art in a dual manner. Finally, it is to be noted that the effects, advantages, and features specified for the converter module apply in equal measure to the inverter equipped with the converter module and vice versa.

What is claimed is:

1. A converter module for a modularly configured inverter, the converter module comprising:
a first and a second module terminal each having a respective positive contact, a respective negative contact, and a respective reference potential contact;
a first semiconductor switch connected to the positive contacts of the first and second module terminals for electrically coupling the positive contacts;
a second semiconductor switch connected to the negative contacts of the first and second module terminals for electrically coupling the negative contacts;
an inductor connected to the reference potential contacts of the first and second module terminals for electrically coupling the reference potential contacts;
a first series circuit comprising a third semiconductor switch and a first capacitor, the first series circuit connected in parallel to the first semiconductor switch;
wherein the first capacitor is connected to the positive contact of the first module terminal, the third semiconductor switch is connected to the positive contact of the second module terminal, and a connection of the third semiconductor switch to the first capacitor is connected to the reference potential contact of the first module terminal via a fifth semiconductor switch; and
a second series circuit comprising a fourth semiconductor switch and a second capacitor connected in parallel to the second semiconductor switch;
wherein the second capacitor is connected to the negative contact of the first module terminal, the fourth semiconductor switch is connected to the negative contact of the second module terminal, and a connection of the fourth semiconductor switch to the second capacitor is connected to the reference potential contact of the first module terminal via a sixth semiconductor switch.

2. The converter module as claimed in claim 1, further comprising a control unit integrated into the converter module for controlling the semiconductor switches.

3. The converter module as claimed in claim 1, wherein the first and the second module terminal each comprise a respective control terminal.

4. The converter module as claimed in claim 1, wherein the first and the second module terminal each comprise a respective coded plug connector unit including the respective positive contact, the respective negative contact, the respective reference potential contact.

5. An inverter comprising:
an AC-voltage terminal with a phase terminal and a neutral conductor terminal; and
a DC-voltage terminal with a positive contact, a negative contact, and a reference potential contact;
wherein the reference potential contact and the neutral conductor terminal are electrically coupled to one another;
a module receptacle including an inverter module terminal with a positive contact, a negative contact, and a reference potential contact, wherein each of the contacts is electrically coupled to the phase contact by a respective seventh, eighth, and ninth semiconductor switch;
wherein the module receptacle is configured to electrically connect at least one converter module comprising:
a first and a second module terminal each having a respective positive contact, a respective negative contact, and a respective reference potential contact;
a first semiconductor switch connected to the positive contacts of the first and second module terminals for electrically coupling the positive contacts;
a second semiconductor switch connected to the negative contacts of the first and second module terminals for electrically coupling the negative contacts;
an inductor connected to the reference potential contacts of the first and second module terminals for electrically coupling the reference potential contacts;
a first series circuit comprising a third semiconductor switch and a first capacitor, the first series circuit connected in parallel to the first semiconductor switch;
wherein the first capacitor is connected to the positive contact of the first module terminal, the third semiconductor switch is connected to the positive contact of the second module terminal, and a connection of the third semiconductor switch to the first capacitor is connected to the reference potential contact of the first module terminal via a fifth semiconductor switch; and
a second series circuit comprising a fourth semiconductor switch and a second capacitor connected in parallel to the second semiconductor switch;
wherein the second capacitor is connected to the negative contact of the first module terminal, the fourth semiconductor switch is connected to the negative contact of the second module terminal, and a connection of the fourth semiconductor switch to the second capacitor is connected to the reference potential contact of the first module terminal via a sixth semiconductor switch;
wherein the inverter module terminal electrically couples the first module terminal, and the DC-voltage terminal electrically couples the second module terminal.

6. The inverter as claimed in claim 5, wherein the module receptacle comprises a converter module to electrically connect a cascade comprising at least two converter modules;
wherein respective first module terminals of a first one of the converter modules are electrically connected to respective second module terminals of respective additional converter modules;
wherein the module receptacle is configured to electrically couple the inverter module terminal to a free first module terminal of the cascade, and to electrically couple the DC-voltage terminal to a free second module terminal of the cascade.

7. The inverter as claimed in claim 5, further comprising an inverter controller connected to a module control terminal of the inverter module terminal;
wherein the module control terminal is configured to be coupled to a control terminal of the converter module.

8. The inverter as claimed in claim 5, wherein the ninth semiconductor switch is configured for bidirectional electrical disconnection of the reference potential contact from the phase contact in a deactivated switching state.
